(19) United States
(12) Patent Application Publication
(10) Pub. No.: US 2012/0109749 A1
(43) Pub. Date: May 3, 2012

(54) Systems and Methods to Provide Recommendations

(75) Inventors: Kaushik Subramanian, Fremont, CA (US); Rafael De la Vega, Menlo Park, CA (US)

(73) Assignee: VISA INTERNATIONAL SERVICE ASSOCIATION, San Francisco, CA (US)

(21) Appl. No.: 13/287,033

(22) Filed: Nov. 1, 2011

Related U.S. Application Data
(60) Provisional application No. 61/409,421, filed on Nov. 2, 2010.

(51) Int. Cl. G06Q 30/02

(52) U.S. Cl. 705/14.53; 705/26.43

(57) ABSTRACT

In one aspect, a computing apparatus stores in a computer readable storage media transaction data related to a plurality of payment card transactions processed at a transaction handler for a group of accounts. Based on the transaction data and user feedback, such as ratings and comments, the computing apparatus computes preference scores to rank merchants and to provide recommendations or suggestions to users of the account group based on the preference scores, such as suggesting hotels or restaurants to business travelers of a company based on spending amount and frequency derived from the transaction data of the corporate credit card accounts of the company.

### RELATED APPLICATIONS

The present application claims priority to Prov. U.S. Pat. App. Ser. No. 61/409,421, filed Nov. 2, 2010 and entitled “Systems and Methods to Provide Recommendations,” the disclosure of which is incorporated herein by reference.

### FIELD OF THE TECHNOLOGY

At least some embodiments of the present disclosure relate to the processing of transaction data, such as records of payments made via credit cards, debit cards, prepaid cards, etc., and/or providing information based on the processing of the transaction data.

### BACKGROUND

Millions of transactions occur daily through the use of payment cards, such as credit cards, debit cards, prepaid cards, etc. Corresponding records of the transactions are recorded in databases for settlement and financial recordkeeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” discloses a system in which a targeted advertisement is delivered to a computer in response to receiving an identifier, such as a cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

U.S. Pat. App. Pub. No. 2010/0256982, published on Oct. 7, 2010 and entitled “System and Method for Predicting Card Member Spending Using Collaborative Filtering,” discloses a system that allows a credit or charge card issuer to provide its card members with a list of restaurants that might be of interest based on the financial transactions of similar card members.

U.S. Pat. App. Pub. No. 2010/0125490, published on May 20, 2010 and entitled “Social Network Referral Coupons,” discloses a system that facilitates enhancing coupon distribution in a non-evasive manner based upon a referral.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a system to provide recommendations according to one embodiment.

FIGS. 2-3 show methods to provide recommendations according to some embodiments.

FIG. 4 shows a system to provide information based on transaction data according to one embodiment.

FIG. 5 illustrates a transaction terminal according to one embodiment.

FIG. 6 illustrates an account identifying device according to one embodiment.

FIG. 7 illustrates a data processing system according to one embodiment.

### DETAILED DESCRIPTION

In one embodiment, a transaction handler (e.g., a processor of credit cards, debit cards, prepaid cards) is configured to assist travelers via recommending merchants or businesses (e.g., hotels, restaurants) based on, or derived from, transactional data of a group of accounts, such as the corporate credit card accounts of a company. In one embodiment, users are required to enroll in a service program and provide consent to allow the system to use related transaction data and/or other data for the related services. The system is configured to provide the services while protecting the privacy of the users in accordance with the enrollment agreement and user consent.

In one embodiment, a business travel social networking site is configured to provide services and/or suggestions based on the transaction data recorded at the transaction handler and/or the feedback data from account holders or cardholders who have used the accounts in the group to pay for purchases during their travel. For example, business travelers are provided with access to the social networking site via a web portal and/or their mobile devices, such as mobile phones, personal digital assistants, notebook computers, handheld computers, etc. to receive recommendations or suggestions.

In one embodiment, the transaction handler and the social networking site use the transaction data of a particular business (e.g., a company or a corporation) to assist the travelers of the business to select merchants during their travel or during the planning of their travel.

For example, the historical transaction data for the corporate accounts of the company (e.g., corporate credit accounts, corporate debit accounts, corporate prepaid accounts) is analyzed in one embodiment to determine the spending frequency and the spending amount by the cardholders/account holders of the respective corporate accounts of the company with merchants such as hotels, restaurants, and/or other businesses that are of interest to typical business travelers. The spending frequency and the spending amount are used to determine a preference score to rank the merchants. When a traveler of the company is interested in a type of merchants in a particular geographic area, such as hotels or restaurants at the destination of a trip or in the city in which the traveler is currently traveling, the social networking site is to provide a list of relevant merchants, ordered according to the preference score computed using the spending frequencies and the spending amounts, or to recommend the top ranking merchant(s).

In one embodiment, the recommendations or suggestions are provided in accordance with company spending thresholds, such as spending limits provided in a company travel policy.

In one embodiment, the previous transaction history can be used to identify potential fraudulent transactions and provide alerts to card holders. For example, the spending patterns in the accounts of the business are determined via analyzing the transaction data of the accounts. When a transaction in one of the accounts of the business is not consistent with the spending patterns, an alert or notification is transmitted to the respective account holder (e.g., via an email, a short message service message, an instant message, a message pushed to a mobile device of the account holder, a voice message to a mobile phone of the account holder). In one embodiment, the alert or notification is provided in real time with the processing of the transaction (e.g., in parallel with the transaction handler processing the authorization request for the transaction).

In one embodiment, the portal configured to provide the recommendations and/or alerts is configured as an intranet portal for the company. Since the group of accounts are under the control of the company, the company has the right to use the transaction data to serve the travelers of the company. In one embodiment, the intranet portal of the company is connected to the transaction handler to provide the recommendations and/or alerts. The intranet portal limits the access to the recommendations that are based on, or derived from, transactional data of the group of accounts to authorized users of the respective accounts, such as the cardholders or account holders of the corporate credit card accounts of the company, to improve security and privacy.

In one embodiment, the transaction handler is configured to compute the preference scores and provide ranked lists of merchants in response to queries from the intranet portal. For example, in one embodiment, the transaction handler is configured to use the transaction data of the accounts under the control of the company to update the preference scores of the merchants periodically (e.g., monthly, quarterly, semi-annually, yearly); and the intranet portal is configured to store the preference scores of various merchants and provide recommendations based at least in part on the preference scores. In one embodiment, the intranet portal is further configured to provide the recommendations based on other information, such as the current location of the traveler/account holder, the intended destination of the traveler/account holder, the locations of the merchants, the distances between the merchants and the current location or the intended destination of the traveler/account holder, etc.

In one embodiment, the preference scores are provided to the portal in response to a query from the portal. The query may further specify a relevant location and the relevant merchant category, such as hotels, restaurants, etc. In response to the query, records in the accounts of the company for transactions with merchants near the relevant location and in the relevant merchant category are retrieved to compute the preference scores of the merchants. In one embodiment, the merchants are sorted according to the preference scores; and a set of top merchants are identified in the response to the query (other merchants are not reported in the response to the query).

In one embodiment, the accounts used for computing the preference scores include accounts for individual consumers; and the account holders or cardholders can optionally join the group to allow their transaction data to be used for recommendations within the group and to receive recommendations as a member of the group. For example, in one embodiment, a social networking group is formed on a social networking site to allow the preference scores to be computed for merchants in a category using the transaction data in the group. For example, in one embodiment, the group is based on a “friend” relationship established in the social networking site. In one embodiment, a user may specify a subset of friends of the user in the social networking site to form the group.

In one embodiment, the group includes the friends of a user in a social networking site. For example, in one embodiment, when a pair of users in the social networking site confirm a friend relationship, the users provide the consent to allow the social networking site to use the transaction data to provide recommendations for confirmed friends. Thus, for each of the users in the social networking site, the transaction data in the accounts of a group of friends of the respective users can be used to rank merchants for recommendations related to travel or other activities, such as shopping, entertainment, dining, etc.

In one embodiment, the social networking site is configured to allow friends to mutually confirm each other for the purpose of using their transaction data for making recommendations for the other. For example, a pair of users may each provide information to the social networking site to confirm that the other user should be treated as a “friend” of the respective user in the social networking site to establish the “friend” relationship in the social networking site. In one embodiment, establishing the “friend” relationship implies the consent to allow the transaction handler to use the transaction data of the users to make recommendations for their friends, via the computing of the preference scores of merchants.

In one embodiment, a pair of users may each explicitly provide consent to allow the transaction handler to include the transaction data of the user as part of the transaction data of the “friends” of the other user to make recommendations for the other user.

In one embodiment, the pair of users are required to both provide the consent to allow the transaction handler to use their transaction data for recommendations for the other user to establish the “recommendation friend” relationship. In one embodiment, to make a recommendation for a user, the recommendation friends of the user are identified based on the “recommendation friend” relationships established within the social networking site. The transaction data of the recommendation friends of the user are used to compute the reference scores of merchants. The transaction data of other friends of the user in the social networking site is not used.

In one embodiment, a user may provide consent to allow the transaction handler to use the transaction data of the user to compute the preference score for one or more selected friends of the user, without requiring that respective friends provide the consent to allow the transaction handler to use the transaction data of the respective friends to compute the preference score for the user. To make a recommendation for the user, the transaction handler is configured to identify the friends of the user who have provided consents to allow the transaction handler to use their transaction data to compute the preference score for the user. Such friends form a group; and the transaction data of the group is used to compute the preference scores of merchants for the user.

In one embodiment, to compute the preference scores of merchants for a user, the transaction data of the user is excluded from the data used to compute the preference scores. Thus, the preference scores do not include the preference of the user.

In one embodiment, to compute the preference scores of merchants for a user, the transaction data of the user is included in the data used to compute the preference scores. Thus, the preference scores include the preference of the user. In one embodiment, the transaction data of the user and the transaction data of other users are provided with different weights to balance the preference of the user and the preferences of others in the group (e.g., other friends, or other employees of the business). In one embodiment, the portal provides a user interface to allow the user to select the weights for balancing the preference of the user and the preferences of others in the group.

In one embodiment, the members in the group may further provide feedback on transactions and/or merchants, such as ratings of the services and/or qualities, comments about experiences with the merchants and/or at the merchant locations, etc. The social networking site is configured to provide the feedback about the recommended merchants to assist the traveler.

For example, the portal in one embodiment provides a user interface to allow a user to view a record of a transaction in the account of the user. In connection with presenting the record (e.g., the date and time of the transaction, the identity of the merchant of the transaction, the amount of the transaction), the user interface allows the user to specify a rating and/or provide a comment regarding the transaction. In one embodiment, the ratings specified by the users in the group for a merchant are used to compute an average rating of the merchant; and the average rating is presented and/or used in the selection of recommended merchants.

In one embodiment, when presenting recommended merchants, the portal provides information including the preference score, the average rating, and/or a list of comments from users in the group (e.g., friends of the user who receives the recommendation, or other employees of the business).

In one embodiment, the recommendations are provided in response to a transaction of a user. For example, during the processing of the authorization request for a payment transaction using the account of the user for a travel arrangement, the destination information of the travel arrangement can be used to determine a location of interest to the user; and in response, the merchants of interest to a typical traveler, such as hotels and restaurants, are identified for the location of interest, sorted according to preferences, and selectively presented to the user. The selection of the recommended merchants may be further based on the transaction profile of the user, the company policy, and/or the preferences of the user in other aspects, such as user ratings, threshold distance to the merchants, etc.

### System

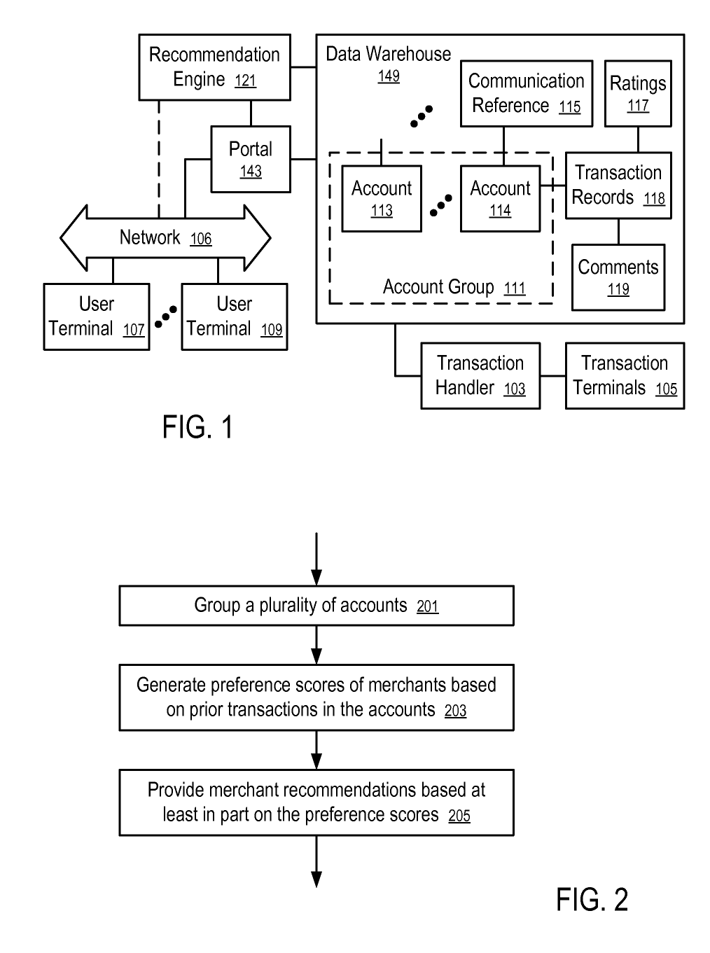

FIG. 1 shows a system to provide recommendations according to one embodiment. In FIG. 1, the system includes transaction terminals (105) to initiate financial transactions, a transaction handler (103) to generate transaction data, such as transaction records (118) from processing the financial transactions of the account (114) (and the financial transactions of other accounts (e.g., 113)), a data warehouse (149) to store the transaction data, a portal (143), and a recommendation engine (121) to generate recommendations based on the transaction data and/or other data, such as ratings (117), comments (119).

In one embodiment, the data warehouse (149) stores data to group a set of accounts (e.g., 113, . . . , 114). The recommendation engine (121) is configured to use the transaction data of the accounts (e.g., 113, . . . , 114) in the account group (111) to rank merchants, such as hotels, restaurants, etc. For example, in one embodiment, the transaction records (e.g., 118) of the accounts (e.g., 113, . . . , 114) in the account group (111) are used by the recommendation engine (121) to determine spending frequencies and spending amounts for purchases from the merchants which were paid for via the accounts (e.g., 113, . . . , 114) in the account group (111). The spending frequencies and spending amounts are used to compute preference scores of the merchants. In one embodiment, the higher the spending frequencies and/or the spending amounts, the higher the preference scores. The preference scores can be used to sort the merchants in a category, such as hotel or restaurant, and to select recommended merchants.

In one embodiment, a preference score of a merchant computed for making a recommendation to a particular user, among the users of the accounts (113, . . . , 114), is based on the transaction records (118) of the group (111). The preference score is not customized for the particular user for which the recommendation is made.

In one embodiment, the same preference score is computed based on the transaction records (118) in the account group (111), regardless of the identity of the user to whom the recommendation is to be made.

In one embodiment, the transaction records (118) of the users in the account group (111) are provided with different weights. For example, the transactions of the user to whom the recommendation is to be made are given zero weight to effectively exclude the transactions of the user from the computation of the preference score for the user. Alternatively, the transactions of the user to whom the recommendation is to be made are given a weight higher than the weight for transactions of other users in computing the preference score for the user. In one embodiment, the weights are based on a preference setting specified by the user.

In one embodiment, the cardholders or account holders of the accounts (e.g., 113, . . . , 114) can use the user terminals (e.g., 107, . . . , 109) to access the portal (143) for the recommendations via the network (106). In one embodiment, a user terminal (107) is a point of interaction, such as a computer, a mobile phone, a personal digital assistant, a handheld computer, etc. After the user of a user terminal (e.g., 107, . . . , 109) is authenticated and determined to be a user of an account (e.g., 114) of the group (111), recommended or suggested merchants are presented to the user via the portal (143). For example, the user may specify a location and a merchant category to request a list of recommended merchants, sorted according to the preference scores of the respective merchants.

In one embodiment, the portal (143) provides information via a website, a telephonic voice portal, a server interacting with mobile applications, etc.

In one embodiment, the account (114) is linked to a communication reference (115) of the user of the account (114). Examples of the communication reference (115) include email addresses, mobile phone numbers, user names for instant messaging systems, etc.

In one embodiment, the recommendations are provided to the user terminal (e.g., 109) of the user, in response to a request from the user terminal (e.g., 109) transmitted to the portal (143). In another embodiment, the recommendations are provided to the user terminal (e.g., 109) via the portal (143) using the communication reference (115) in response to an event associated with the account (114) of the user, such as a payment made using the account (114), the detection of a location of the user of the account (114), etc.

In one embodiment, the user terminals (e.g., 107, . . . , 109) are configured to access the recommendation engine (121) for recommendations or suggestions; and the recommendation engine (121) is configured to communicate with the portal (143) of the transaction handler (103) to provide information for the identification and ordering of the merchants, such as a list of merchants, the preference scores of the merchants, offers or advertisements from the merchants, etc.

In one embodiment, the account group (111) is formed based on a common entity to which the account holders of the accounts (113, . . . , 114) relate. For example, the common entity may be a business which provides the business accounts (113, . . . , 114) to the respective users of the business accounts (113, . . . , 114).

For example, the common entity may be a user to which the users of the accounts (113, . . . , 114) are registered as friends of the user in a social networking site (e.g., hosted on the portal (143) or a third party server). In one embodiment, the accounts (113, . . . , 114) correspond to a subset of the friends of the user, to which recommendations are to be made, where the subset of friends have previously provided consent to allow the recommendation engine (121) to use their transaction records (118) to compute the preference score for the user.

In FIG. 1, the portal is configured to allow the user of the account (114) to view the transaction records (118) in the respective records, submit ratings (117) for the merchants involved in the transaction records (118), and/or provide comments (119) regarding the respective merchants and/or the purchase transactions. In one embodiment, the user of the account (114) can provide a separate rating and a separate comment for each of the transactions in the records (118).

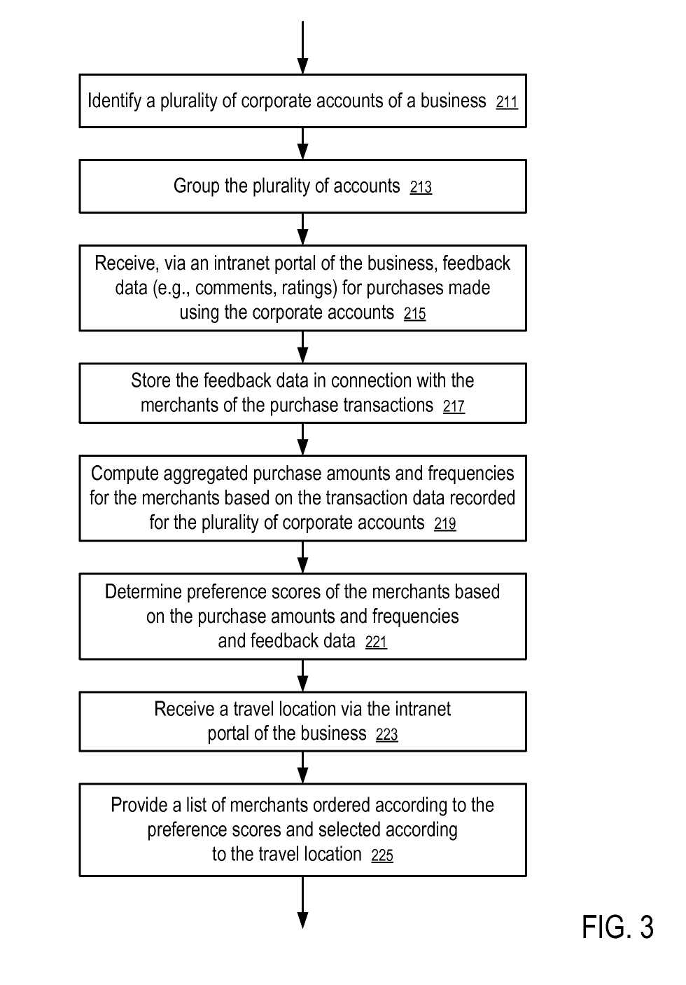

FIGS. 2-3 show methods to provide recommendations according to some embodiments. In FIG. 2, a computing apparatus is configured to group (201) a plurality of accounts (e.g., 113, . . . , 114), generate (203) preference scores of merchants based on prior transactions in the accounts (e.g., 113, . . . , 114), and provide (205) merchant recommendations based at least in part on the preference scores.

In one embodiment, the preference score computed using the transaction records (e.g., 118) of the accounts (113, . . . , 114) is the same for each of the users of the accounts (113, . . . , 114).

In one embodiment, the computing apparatus is configured to store data grouping a plurality of accounts (113, . . . , 114), store transaction data (e.g., transaction records (118) of the plurality of accounts (113, . . . , 114)), determine preference scores of merchants based at least in part on spending amounts recorded in the transaction data of the plurality of accounts (113, . . . , 114), and provide recommendations of merchants based on the preference scores to an account holder of a first account (114) of the plurality of accounts (113, . . . , 114).

In one embodiment, the computing device is configured to receive a request identifying the first account (114) of the plurality accounts (113, . . . , 114) via a portal (143) of a business; and the plurality of accounts (113, . . . , 114) are issued to account holders of the business. In one embodiment, the recommendations are provided to an account holder of the first account (114) via the portal (143) of the business.

In one embodiment, the request identifies a location; and the recommendations are for merchants located in the vicinity of the location.

In one embodiment, the recommendations are related to at least one of: hotels and restaurants; and the recommendations are further in accordance with travel policies of the business.

In one embodiment, the computing apparatus is configured to receive feedback data from the account holders of the business, such as comments (119) and ratings (117); and the recommendations provided in response to the request include the feedback data related to respective merchants.

In one embodiment, the computing apparatus is configured to provide a user interface to the user to view records of transactions of the user recorded in the transaction data; and the user interface is further configured to receive comments (e.g., 119) on and ratings (e.g., 117) of merchants for respective transactions.

In one embodiment, the preference scores are further based on spending frequency of transactions with the merchants as recorded in the transaction data of the plurality of accounts.

In one embodiment, the computing apparatus is configured to identify a spending pattern in the transaction data of the plurality of accounts, and detect a fraudulent transaction in the first account (114) of the plurality of accounts based on the spending pattern.

In one embodiment, the computing apparatus is configured to store a communication reference (115) of the account holder in association with the first account (114) and to transmit an alert to the account holder using the communication reference (115) in response to the fraudulent transaction being detected based on the spending pattern.

In one embodiment, the computing apparatus is configured to monitor transactions in the first account (114) to provide recommendations in response to transactions relevant to the recommendations. For example, in one embodiment, the recommendations are provided further based on a location of a mobile device of the account holder. In one embodiment, the recommendations are provided to the mobile device.

In one embodiment, the plurality of accounts (113, . . . , 114) are grouped via a social networking application.

In one embodiment, the computing apparatus is configured to communicate with a social networking site to determine friends of the account holder of the first account (114), and identify the plurality of accounts (113, . . . , 114) based on identities of the friends.

In one embodiment, the computing apparatus includes at least one of: the recommendation engine (121), the data warehouse (149), the portal (143) and the transaction handler (103).

In one embodiment, the computing apparatus includes an advertisement selector coupled with the data warehouse (149) to identify a recommendation of a first merchant in response to a first transaction in the set of accounts (113, . . . , 114).

In one embodiment, the computing apparatus includes a media controller coupled with the advertisement selector to transmit the recommendation to a mobile device of a user of the first transaction.

In one embodiment, the advertisement selector is configured to select the recommendation based on a distance between the mobile device of the user of the first transaction and a location of the first merchant.

In one embodiment, the computing apparatus includes a transaction profile generator coupled with the data warehouse (149) to generate a transaction profile of the user, where the recommendation is further selected based on the transaction profile.

Details and examples of the advertisement selector, the media controller and the transaction profile generator according to one embodiment are provided in U.S. Pat. App. Pub. No. 2011/0087550, published on Apr. 14, 2011 and entitled “Systems and Methods to Deliver Targeted Advertisements to Audience,” the entire disclosure of which is incorporated herein by reference.

In FIG. 3, the computing apparatus is configured to identify (211) a plurality of corporate accounts (e.g., 113, . . . , 114) of a business, group (213) the plurality of accounts (e.g., 113, . . . , 114), receive (215), via an intranet portal (143) of the business, feedback data (e.g., comments (119), ratings (117)) for purchases made using the corporate accounts (e.g., 113, . . . , 114), store (217) the feedback data (e.g., 117, 119) in connection with the merchants of the purchase transactions, compute (219) aggregated purchase amounts and frequencies for the merchants based on the transaction data (e.g., 118) recorded for the plurality of corporate accounts (e.g., 117, 119), determine (221) preference scores of the merchants based on the purchase amounts and frequencies and feedback data, receive (223) a travel location via the intranet portal (143) of the business, and provide (225) a list of merchants ordered according to the preference scores and selected according to the travel location.

In one embodiment, the recommendations are provided as part of an advertisement, or in a way similar to an advertisement. For example, in the embodiment, the recommendation is based at least in part on the transaction profile of the user generated from the transaction data (e.g., 118). For example, an aggregated spending profile of the user can be generated via factor analysis and cluster analysis to summarize the spending patterns/behaviors reflected in the transaction records (118).

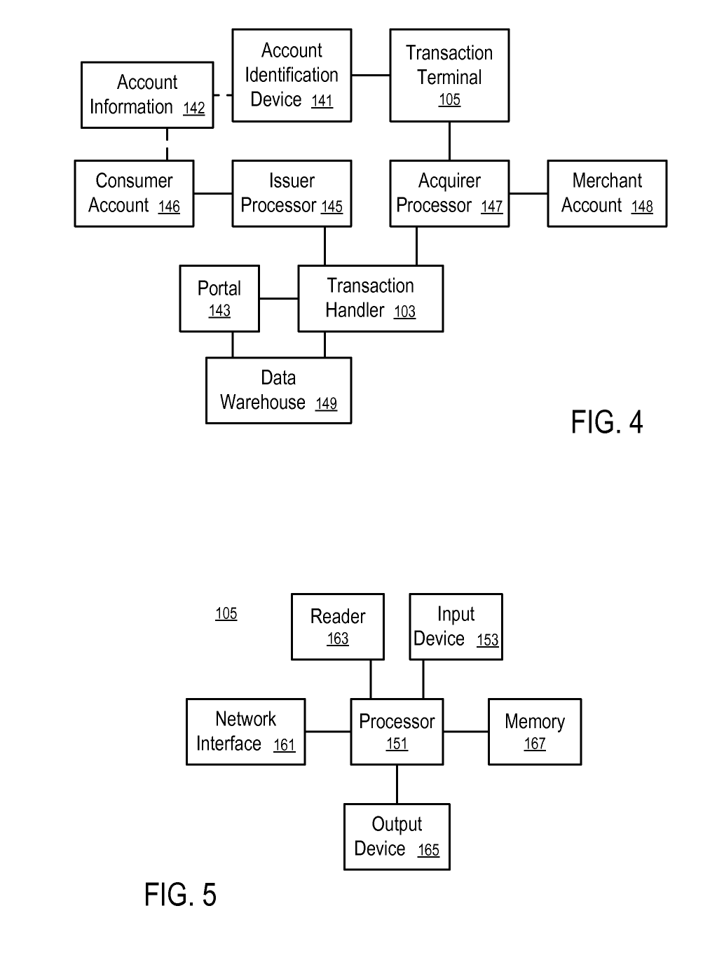

In one embodiment, a data warehouse (149) and the transaction handler (103) are configured in a way as illustrated in FIG. 4, to store the transaction data (e.g., 118) and other data, such as account data, transaction profiles, etc. In FIG. 4, the portal (143) is coupled with the data warehouse (149) to provide data or information derived from the transaction data (e.g., 118), in response to a query request from a third party or as an alert or notification message.

In FIG. 4, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user and the merchant.

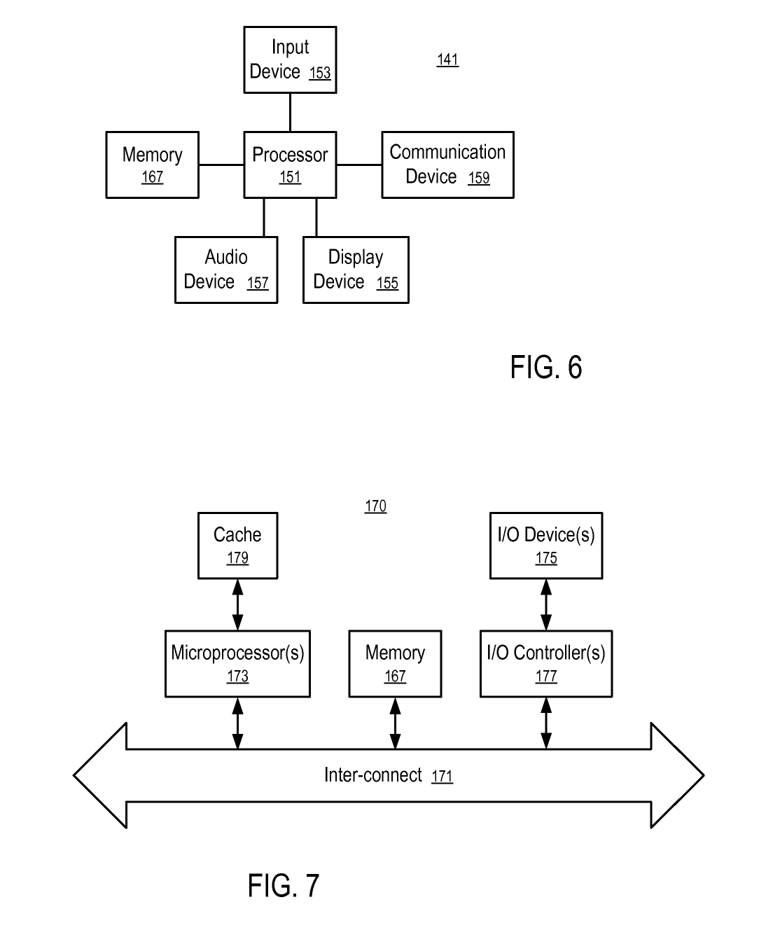

FIGS. 5 and 6 illustrate examples of transaction terminals (105) and account identification devices (141). FIG. 7 illustrates the structure of a data processing system that can be used to implement, with more or fewer elements, at least some of the components in the system, such as the transaction handler (103), the portal (143), the data warehouse (149), the account identification device (141), the transaction terminal (105), etc. Some embodiments use more or fewer components than those illustrated in FIGS. 1 and 4-7, as further discussed in the section entitled “VARIATIONS.”

In one embodiment, the transaction data relates to financial transactions processed by the transaction handler (103); and the account data relates to information about the account holders involved in the transactions. Further data, such as merchant data that relates to the location, business, products and/or services of the merchants that receive payments from account holders for their purchases, can be used in the generation of the transaction profiles.

In one embodiment, the financial transactions are made via an account identification device (141), such as financial transaction cards (e.g., credit cards, debit cards, banking cards); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) maintains a centralized data warehouse (149) organized around the transaction data (e.g., 118). For example, the centralized data warehouse (149) may include, and/or support the determination of, spending band distribution, transaction count and amount, merchant categories, merchant by state, cardholder segmentation by velocity scores, and spending within merchant target, competitive set and cross-section.

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (e.g., 118) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (e.g., 118) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In one embodiment, a profile generator generates transaction profiles based on the transaction data, the account data, and/or other data, such as non-transactional data, wish lists, merchant provided information, address information, information from social network websites, information from credit bureaus, information from search engines, and other examples discussed in U.S. patent application Ser. No. 12/614,603, filed Nov. 9, 2009 and entitled “Analyzing Local Non-Transactional Data with Transactional Data in Predictive Models,” the disclosure of which is hereby incorporated herein by reference.

In one embodiment, the transaction profiles provide intelligence information on the behavior, pattern, preference, propensity, tendency, frequency, trend, and budget of the user in making purchases. In one embodiment, the transaction profiles include information about what the user owns, such as points, miles, or other rewards currency, available credit, and received offers, such as coupons loaded into the accounts of the user. In one embodiment, the transaction profiles include information based on past offer/coupon redemption patterns. In one embodiment, the transaction profiles include information on shopping patterns in retail stores as well as online, including frequency of shopping, amount spent in each shopping trip, distance of merchant location (retail) from the address of the account holder(s), etc.

In one embodiment, the transaction handler (103) provides at least part of the intelligence for the prioritization, generation, selection, customization and/or adjustment of an advertisement for delivery within a transaction process involving the transaction handler (103). For example, the advertisement may be presented to a customer in response to the customer making a payment via the transaction handler (103).

Some of the transaction profiles are specific to the user, or to an account of the user, or to a group of users of which the user is a member, such as a household, family, company, neighborhood, city, or group identified by certain characteristics related to online activities, offline purchase activities, merchant propensity, etc.

In one embodiment, the transaction profiles include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles in one embodiment are provided in the section entitled “AGGREGATED SPENDING PROFILE.”

### Non-Transactional Data

In one embodiment, the transaction data is analyzed in connection with non-transactional data to generate transaction profiles and/or to make predictive models.

In one embodiment, transactions are correlated with non-transactional events, such as news reports, conferences, shows, announcements, market changes, natural disasters, etc. to establish cause and effect relationships to predict future transactions or spending patterns. For example, non-transactional data may include the geographic location of a news event, the date of an event from an events calendar, the name of a performer for an upcoming concert, etc. The non-transactional data can be obtained from various sources, such as newspapers, websites, blogs, social networking sites, etc.

In one embodiment, when the cause and effect relationships between the transactions and non-transactional events are known (e.g., based on prior research results, domain knowledge, expertise), the relationships can be used in predictive models to predict future transactions or spending patterns, based on events that occurred recently or are happening in real-time.

In one embodiment, the non-transactional data relates to events that happened in a geographical area local to the user that performed the respective transactions. In one embodiment, a geographical area is local to the user when the distance from the user to locations in the geographical area is within a convenient range for daily or regular travel, such as 20, 50 or 100 miles from an address of the user, or within the same city or zip code area of an address of the user. Examples of analyses of local non-transactional data in connection with transaction data in one embodiment are provided in U.S. patent application Ser. No. 12/614,603, filed Nov. 9, 2009 and entitled “Analyzing Local Non-Transactional Data with Transactional Data in Predictive Models,” the disclosure of which is hereby incorporated herein by reference.

In one embodiment, the non-transactional data is not limited to local non-transactional data. For example, national non-transactional data can also be used.

In one embodiment, the transaction records (118) are analyzed in frequency domain to identify periodic features in spending events. The periodic features in the past transaction records (118) can be used to predict the probability of a time window in which a similar transaction will occur. For example, the analysis of the transaction data can be used to predict when a next transaction having the periodic feature will occur, with which merchant, the probability of a repeated transaction with a certain amount, the probability of exception, the opportunity to provide an advertisement or offer such as a coupon, etc. In one embodiment, the periodic features are detected through counting the number of occurrences of pairs of transactions that occurred within a set of predetermined time intervals and separating the transaction pairs based on the time intervals. Some examples and techniques for the prediction of future transactions based on the detection of periodic features in one embodiment are provided in U.S. patent application Ser. No. 12/773,770, filed May 4, 2010 and entitled “Frequency-Based Transaction Prediction and Processing,” the disclosure of which is hereby incorporated herein by reference.

Techniques and details of predictive modeling in one embodiment are provided in U.S. Pat. Nos. 6,119,103, 6,018,723, 6,658,393, 6,598,030, and 7,227,950, the disclosures of which applications are hereby incorporated herein by reference.

In one embodiment, offers are based on the point-of-service to offeree distance to allow the user to obtain in-person services. In one embodiment, the offers are selected based on transaction history and shopping patterns in the transaction data (e.g., 118) and/or the distance between the user and the merchant. In one embodiment, offers are provided in response to a request from the user, or in response to a detection of the location of the user. Examples and details of at least one embodiment are provided in U.S. patent application Ser. No. 11/767,218, filed Jun. 22, 2007, assigned Pub. No. 2008/0319843, and entitled “Supply of Requested Offer Based on Point-of Service to Offeree Distance,” U.S. patent application Ser. No. 11/755,575, filed May 30, 2007, assigned Pub. No. 2008/0300973, and entitled “Supply of Requested Offer Based on Offeree Transaction History,” U.S. patent application Ser. No. 11/855,042, filed Sep. 13, 2007, assigned Pub. No. 2009/0076896, and entitled “Merchant Supplied Offer to a Consumer within a Predetermined Distance,” U.S. patent application Ser. No. 11/855,069, filed Sep. 13, 2007, assigned Pub. No. 2009/0076925, and entitled “Offeree Requested Offer Based on Point-of Service to Offeree Distance,” and U.S. patent application Ser. No. 12/428,302, filed Apr. 22, 2009 and entitled “Receiving an Announcement Triggered by Location Data,” the disclosures of which applications are hereby incorporated herein by reference.

### Targeting Advertisement

In one embodiment, an advertisement selector prioritizes, generates, selects, adjusts, and/or customizes the available advertisement data to provide user specific advertisement data based at least in part on a user specific profile. The advertisement selector uses the user specific profile as a filter and/or a set of criteria to generate, identify, select and/or prioritize advertisement data for the user. A media controller delivers the user specific advertisement data to the point of interaction for presentation to the user as the targeted and/or personalized advertisement.

In one embodiment, the user data includes the characterization of the context at the point of interaction. Thus, the use of the user specific profile, selected using the user data, includes the consideration of the context at the point of interaction in selecting the user specific advertisement data.

In one embodiment, in selecting the user specific advertisement data, the advertisement selector uses not only the user specific profile, but also information regarding the context at the point of interaction. For example, in one embodiment, the user data includes information regarding the context at the point of interaction; and the advertisement selector explicitly uses the context information in the generation or selection of the user specific advertisement data.

In one embodiment, mobile advertisements, such as offers and coupons, are generated and disseminated based on aspects of prior purchases, such as timing, location, and nature of the purchases, etc. In one embodiment, the size of the benefit of the offer or coupon is based on purchase volume or spending amount of the prior purchase and/or a subsequent purchase that may qualify for the redemption of the offer. Further details and examples of one embodiment are provided in U.S. patent application Ser. No. 11/960,162, filed Dec. 19, 2007, assigned Pub. No. 2008/0201226, and entitled “Mobile Coupon Method and Portable Consumer Device for Utilizing Same,” the disclosure of which is hereby incorporated herein by reference.

In one embodiment, conditional rewards are provided to the user; and the transaction handler (103) monitors the transactions of the user to identify redeemable rewards that have satisfied the respective conditions. In one embodiment, the conditional rewards are selected based on transaction data. Further details and examples of one embodiment are provided in U.S. patent application Ser. No. 11/862,487, filed Sep. 27, 2007 and entitled “Consumer Specific Conditional Rewards,” the disclosure of which is hereby incorporated herein by reference. The techniques to detect the satisfied conditions of conditional rewards can also be used to detect the transactions that satisfy the conditions specified to locate the transactions that result from online activities, such as online advertisements, searches, etc., to correlate the transactions with the respective online activities.

Further details about targeted offer delivery in one embodiment are provided in U.S. patent application Ser. No. 12/185,332, filed Aug. 4, 2008, assigned Pub. No. 2010/0030644, and entitled “Targeted Advertising by Payment Processor History of Cashless Acquired Merchant Transaction on Issued Consumer Account,” and in U.S. patent application Ser. No. 12/849,793, filed Aug. 3, 2010 and entitled “Systems and Methods for Targeted Advertisement Delivery, the disclosures of which applications are hereby incorporated herein by reference.

Details of presenting targeted advertisements on ATMs based on purchasing preferences and location data in one embodiment are provided in U.S. patent application Ser. No. 12/266,352, filed Nov. 6, 2008 and entitled “System Including Automated Teller Machine with Data Bearing Medium,” the disclosure of which is hereby incorporated herein by reference.

Details of presenting targeted advertisements during the process of authorizing a financial payment card transaction in one embodiment are provided in U.S. patent application Ser. No. 11/799,549, filed May 1, 2007, assigned Pub. No. 2008/0275771, and entitled “Merchant Transaction Based Advertising,” the disclosure of which is hereby incorporated herein by reference.

In one embodiment, the user specific advertisement data, such as recommendations, suggestions, offers or coupons, is provided to the user via the transaction terminal (105) in connection with an authorization message during the authorization of a transaction processed by the transaction handler (103). The authorization message can be used to communicate the rewards qualified for by the user in response to the current transaction, the status and/or balance of rewards in a loyalty program, etc. Examples and details related to the authorization process in one embodiment are provided in U.S. patent application Ser. No. 11/266,766, filed Nov. 2, 2005, assigned Pub. No. 2007/0100691, and entitled “Method and System for Conducting Promotional Programs,” the disclosure of which is hereby incorporated herein by reference.

In one embodiment, when the user is conducting a transaction with a first merchant via the transaction handler (103), the transaction handler (103) may determine whether the characteristics of the transaction satisfy the conditions specified for an announcement, such as an advertisement, offer or coupon, from a second merchant. If the conditions are satisfied, the transaction handler (103) provides the announcement to the user. In one embodiment, the transaction handler (103) may auction the opportunity to provide the announcements to a set of merchants. Examples and details related to the delivery of such announcements in one embodiment are provided in U.S. patent application Ser. No. 12/428,241, filed Apr. 22, 2009 and entitled “Targeting Merchant Announcements Triggered by Consumer Activity Relative to a Surrogate Merchant,” the disclosure of which is hereby incorporated herein by reference.

Details about delivering advertisements at a point of interaction that is associated with user transaction interactions in one embodiment are provided in U.S. patent application Ser. No. 12/849,791, filed Aug. 3, 2010 and entitled “Systems and Methods to Deliver Targeted Advertisements to Audience,” the disclosure of which is hereby incorporated herein by reference.

### Loyalty Program

In one embodiment, the transaction handler (103) uses the account data to store information for third party loyalty programs. The transaction handler (103) processes payment transactions made via financial transaction cards, such as credit cards, debit cards, banking cards, etc.; and the financial transaction cards can be used as loyalty cards for the respective third party loyalty programs. Since the third party loyalty programs are hosted on the transaction handler (103), the consumers do not have to carry multiple, separate loyalty cards (e.g., one for each merchant that offers a loyalty program); and the merchants do not have to incur a large setup and investment fee to establish the loyalty program. The loyalty programs hosted on the transaction handler (103) can provide flexible awards for consumers, retailers, manufacturers, issuers, and other types of business entities involved in the loyalty programs. The integration of the loyalty programs into the accounts of the customers on the transaction handler (103) allows new offerings, such as merchant cross-offerings or bundling of loyalty offerings.

In one embodiment, an entity operating the transaction handler (103) hosts loyalty programs for third parties using the account data of the users. A third party, such as a merchant, retailer, manufacturer, issuer or other entity that is interested in promoting certain activities and/or behaviors, may offer loyalty rewards on existing accounts of consumers. The incentives delivered by the loyalty programs can drive behavior changes without the hassle of loyalty card creation. In one embodiment, the loyalty programs hosted via the accounts of the users of the transaction handler (103) allow the consumers to carry fewer cards and may provide more data to the merchants than traditional loyalty programs.

The loyalty programs integrated with the accounts of the users of the transaction handler (103) can provide tools to enable nimble programs that are better aligned for driving changes in consumer behaviors across transaction channels (e.g., online, offline, via mobile devices). The loyalty programs can be ongoing programs that accumulate benefits for customers (e.g., points, miles, cash back), and/or programs that provide one time benefits or limited time benefits (e.g., rewards, discounts, incentives).

Examples of loyalty programs offered through collaboration between collaborative constituents in a payment processing system, including the transaction handler (103) in one embodiment are provided in U.S. patent application Ser. No. 11/767,202, filed Jun. 22, 2007, assigned Pub. No. 2008/0059302, and entitled “Loyalty Program Service,” U.S. patent application Ser. No. 11/848,112, filed Aug. 30, 2007, assigned Pub. No. 2008/0059306, and entitled “Loyalty Program Incentive Determination,” and U.S. patent application Ser. No. 11/848,179, filed Aug. 30, 2007, assigned Pub. No. 2008/0059307, and entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. patent application Ser. No. 11/835,100, filed Aug. 7, 2007, assigned Pub. No. 2008/0059303, and entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. patent application Ser. No. 11/945,907, filed Nov. 27, 2007, assigned Pub. No. 2008/0071587, and entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. patent application Ser. No. 10/401,504, filed Mar. 27, 2003, assigned Pub. No. 2004/0054581, and entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user, are rewarded with offers/benefits from merchants. The portal (143) and/or the transaction handler (103) track the transaction records for the merchants for the reward or loyalty programs. Further details and examples of one embodiment are provided in U.S. patent application Ser. No. 11/688,423, filed Mar. 20, 2007, assigned Pub. No. 2008/0195473, and entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. patent application Ser. No. 12/177,530, filed Jul. 22, 2008, assigned Pub. No. 2009/0030793, and entitled “Multi-Vender Multi-Loyalty Currency Program,” the disclosure of which is hereby incorporated herein by reference.

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (e.g., 118). In one embodiment, the transaction handler (103) automatically applies the benefits of the offers during the processing of the transactions when the transactions satisfy the conditions associated with the offers. In one embodiment, the transaction handler (103) communicates with transaction terminals (e.g., 105) to set up, customize, and/or update offers based on market focus, product categories, service categories, targeted consumer demographics, etc. Further details and examples of one embodiment are provided in U.S. Pat. application Ser. No. 12/413,097, filed Mar. 27, 2009, assigned Pub. No. 2010-0049620, and entitled “Merchant Device Support of an Integrated Offer Network,” the disclosure of which is hereby incorporated herein by reference.

In one embodiment, the transaction handler (103) is configured to provide offers from merchants to the user via the payment system, making accessing and redeeming the offers convenient for the user. The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user. Further details and examples of one embodiment are provided in Prov. U.S. Pat. App. Ser. No. 61/222,287, filed Jul. 1, 2009 and entitled “Benefits Engine Providing Benefits Based on Merchant Preferences,” the disclosure of which is hereby incorporated herein by reference.

Details on loyalty programs in one embodiment are provided in U.S. patent application Ser. No. 12/896,632, filed Oct. 1, 2010 and entitled “Systems and Methods to Provide Loyalty Programs,” the disclosure of which is hereby incorporated herein by reference.

### SKU

In one embodiment, merchants generate stock-keeping unit (SKU) or other specific information that identifies the particular goods and services purchased by the user or customer. The SKU information may be provided to the operator of the transaction handler (103) that processed the purchases. The operator of the transaction handler (103) may store the SKU information as part of transaction data (e.g., 118), and reflect the SKU information for a particular transaction in a transaction profile associated with the person involved in the transaction.

Details on SKU-level profile in one embodiment are provided in U.S. patent application Ser. No. 12/899,144, filed Oct. 6, 2010 and entitled “Systems and Methods for Advertising Services Based on an SKU-Level Profile,” the disclosure of which is hereby incorporated herein by reference.

### Purchase Details

In one embodiment, the transaction handler (103) is configured to selectively request purchase details via authorization responses. When the transaction handler (103) (and/or the issuer processor (145)) needs purchase details, such as identification of specific items purchased and/or their prices, the authorization responses transmitted from the transaction handler (103) are to include an indicator to request the purchase details for the transaction that is being authorized. The merchants are to determine whether or not to submit purchase details based on whether or not there is a demand indicated in the authorization responses from the transaction handler (103). Further details and examples are provided in U.S. Pat. App. Ser. No. 13/113,710, filed May 23, 2011 and entitled “Systems and Methods for Redemption of Offers,” the disclosure of which is hereby incorporated herein by reference.

### Variations

Some embodiments use more or fewer components than those illustrated in FIGS. 1 and 4-7.

In one embodiment, at least some of the recommendation engine (121), the portal (143), and the data warehouse (149) are controlled by the entity that operates the transaction handler (103). In another embodiment, at least some of the recommendation engine (121), the portal (143), and the data warehouse (149) are not controlled by the entity that operates the transaction handler (103).

For example, in one embodiment, the entity operating the transaction handler (103) provides the intelligence (e.g., transaction profiles or the user specific profile) for the selection of the advertisement; and a third party (e.g., a web search engine, a publisher, or a retailer) may present the advertisement in a context outside a transaction involving the transaction handler (103) before the advertisement results in a purchase.

For example, in one embodiment, the customer may interact with the third party at the point of interaction; and the entity controlling the transaction handler (103) may allow the third party to query for intelligence information (e.g., transaction profiles, or the user specific profile) about the customer using the user data, thus informing the third party of the intelligence information for targeting the advertisements, which can be more useful, effective and compelling to the user. For example, the entity operating the transaction handler (103) may provide the intelligence information without generating, identifying or selecting advertisements; and the third party receiving the intelligence information may identify, select and/or present advertisements.

In one embodiment, the transaction data (e.g., 118) includes transaction amounts, the identities of the payees (e.g., merchants), and the date and time of the transactions. The identities of the payees can be correlated to the businesses, services, products and/or locations of the payees. For example, the transaction handler (103) maintains a database of merchant data, including the merchant locations, businesses, services, products, etc. Thus, the transaction data (e.g., 118) can be used to determine the purchase behavior, pattern, preference, tendency, frequency, trend, budget and/or propensity of the customers in relation to various types of businesses, services and/or products and in relation to time.

In one embodiment, the intelligence information is communicated to various entities in the system in a way similar to, and/or in parallel with the information flow in the transaction system to move money. The transaction handler (103) routes the information in the same way it routes the currency involved in the transactions.

In one embodiment, the portal (143) provides a user interface to allow the user to select items offered on different merchant websites and store the selected items in a wish list for comparing, reviewing, purchasing, tracking, etc. The information collected via the wish list can be used to improve the transaction profiles and derive intelligence on the needs of the user; and targeted advertisements can be delivered to the user via the wish list user interface provided by the portal (143). Examples of user interface systems to manage wish lists are provided in U.S. patent application Ser. No. 12/683,802, filed Jan. 7, 2010 and entitled “System and Method for Managing Items of Interest Selected from Online Merchants,” the disclosure of which is hereby incorporated herein by reference.

### Aggregated Spending Profile

In one embodiment, the characteristics of transaction patterns of customers are profiled via clusters, factors, and/or categories of purchases.

In one embodiment, each of the transaction records (118) is for a particular transaction processed by the transaction handler (103). Each of the transaction records (118) provides information about the particular transaction, such as the account number of the consumer account (146) used to pay for the purchase, the date (and/or time) of the transaction, the amount of the transaction, the ID of the merchant who receives the payment, the category of the merchant, the channel through which the purchase was made, etc. Examples of channels include online, offline in-store, via phone, etc. In one embodiment, the transaction records (118) may further include a field to identify a type of transaction, such as card-present, card-not-present, etc.

In one embodiment, a “card-present” transaction involves physically presenting the account identification device (141), such as a financial transaction card, to the merchant (e.g., via swiping a credit card at a point of sale (POS) terminal of a merchant); and a “card-not-present” transaction involves presenting the account information (142) of the consumer account (146) to the merchant to identify the consumer account (146) without physically presenting the account identification device (141) to the merchant or the transaction terminal (105).

In one embodiment, certain information about the transaction can be looked up in a separate database based on other information recorded for the transaction. For example, a database may be used to store information about merchants, such as the geographical locations of the merchants, categories of the merchants, etc. Thus, the corresponding merchant information related to a transaction can be determined using a merchant ID recorded for the transaction.

In one embodiment, the transaction records (e.g., 118) may further include details about the products and/or services involved in the purchase. For example, a list of items purchased in the transaction may be recorded together with the respective purchase prices of the items and/or the respective quantities of the purchased items. The products and/or services can be identified via stock-keeping unit (SKU) numbers, or product category IDs. The purchase details may be stored in a separate database and be looked up based on an identifier of the transaction.

In one embodiment, the voluminous transaction records are summarized into aggregated spending profiles to concisely present the statistical spending characteristics reflected in the transaction records. The aggregated spending profile uses values derived from statistical analysis to present the statistical characteristics of transaction records of an entity in a way easy to understand by an ordinary person.

Details about aggregated spending profiles in one embodiment are provided in U.S. patent application Ser. No. 12/777,173, filed May 10, 2010 and entitled “Systems and Methods to Summarize Transaction Data,” U.S. patent application Ser. No. 12/537,566, filed Aug. 7, 2009 and entitled “Cardholder Clusters,” and Prov. U.S. Pat. App. Ser. No. 61/182,806, filed Jun. 1, 2009 and entitled “Cardholder Clusters,” the disclosures of which applications are hereby incorporated herein by reference.

### Transaction Data Based Portal

In FIG. 1, the transaction terminal (105) initiates the transaction for a user (e.g., a customer) for processing by a transaction handler (103). The transaction handler (103) processes the transaction and stores transaction data about the transaction, in connection with account data, such as the account profile of an account of the user. The account data may further include data about the user, collected from issuers or merchants, and/or other sources, such as social networks, credit bureaus, merchant provided information, address information, etc. In one embodiment, a transaction may be initiated by a server (e.g., based on a stored schedule for recurrent payments).

Over a period of time, the transaction handler (103) accumulates the transaction data from transactions initiated at different transaction terminals (e.g., 105) for different users. The transaction data (e.g., 118) thus includes information on purchases made by various users at various times via different purchase options (e.g., online purchase, offline purchase from a retail store, mail order, order via phone, etc.)

In one embodiment, the accumulated transaction data and the corresponding account data are used to generate intelligence information about the purchase behavior, pattern, preference, tendency, frequency, trend, amount and/or propensity of the users, as individuals or as a member of a group. The intelligence information can then be used to generate, identify and/or select targeted advertisements for presentation to the users on the point of interaction, during a transaction, after a transaction, or when other opportunities arise.

FIG. 4 shows a system to provide information based on transaction data (e.g., 118) according to one embodiment. In FIG. 4, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records (e.g., 118), such as the transaction profiles or aggregated spending profile. The portal (143) may be implemented as a web portal, a telephone gateway, a file/data server, etc.

In one embodiment, the portal (143) is configured to receive queries identifying search criteria from the recommendation engine (121) or the user terminals (e.g., 107, . . . , 109) to provide transaction-based intelligence requested by the queries.

For example, in one embodiment, a query is to specify a plurality of account holders to request the portal (143) to deliver the transaction profiles of account holders in a batch mode.

For example, in one embodiment, a query is to identify the user to request the user specific profile, or the aggregated spending profile, of the user. The user may be identified using account data, such as an account number, or user data, such as a browser cookie ID, IP address, etc.

For example, in one embodiment, a query is to identify a retail location; and the portal (143) is to provide a profile that summarizes the aggregated spending patterns of users who have shopped at the retail location within a period of time.

For example, in one embodiment, a query is to identify a geographical location; and the portal (143) is to provide a profile that summarizes the aggregated spending patterns of users who have been to, or who are expected to visit, the geographical location within a period of time (e.g., as determined or predicted based on the locations of the points of interaction of the users).

For example, in one embodiment, a query is to identify a geographical area; and the portal (143) is to provide a profile that summarizes the aggregated spending patterns of users who reside in the geographical area (e.g., as determined by the account data, or who have made transactions within the geographical area with a period of time (e.g., as determined by the locations of the transaction terminals (e.g., 105) used to process the transactions).

In one embodiment, the portal (143) is configured to register certain users for various programs, such as a loyalty program to provide rewards and/or offers to the users, a social networking program for the recommendations of certain types of merchants, etc.

In one embodiment, the portal (143) is to register the interest of users, or to obtain permissions from the users to gather further information about the users, such as data capturing purchase details, online activities, etc.

In one embodiment, the user may register via the issuer; and the registration data in the consumer account (146) may propagate to the data warehouse (149) upon approval from the user.

In one embodiment, the portal (143) is to register merchants and provide services and/or information to merchants.

In one embodiment, the portal (143) is to receive information from third parties, such as search engines, merchants, websites, etc. The third party data can be correlated with the transaction data (e.g., 118) to identify the relationships between purchases and other events, such as searches, news announcements, conferences, meetings, etc., and improve the prediction capability and accuracy.

In FIG. 4, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer with an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

In one embodiment, the account identification device (141) is a plastic card having a magnetic strip storing account information (142) identifying the consumer account (146) and/or the issuer processor (145). Alternatively, the account identification device (141) is a smartcard having an integrated circuit chip storing at least the account information (142). In one embodiment, the account identification device (141) includes a mobile phone having an integrated smartcard.

In one embodiment, the account information (142) is printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications (NFC) via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

In one embodiment, the transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

In one embodiment, the transaction handler (103), the issuer processor (145), and the acquirer processor (147) may each include a subsystem to identify the risk in the transaction and may reject the transaction based on the risk assessment.

In one embodiment, the account identification device (141) includes security features to prevent unauthorized uses of the consumer account (146), such as a logo to show the authenticity of the account identification device (141), encryption to protect the account information (142), etc.

In one embodiment, the transaction terminal (105) is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user through a web connection. In one embodiment, the user may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In one embodiment, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., a bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. In one embodiment, dedicated communication channels are used between the transaction handler (103) and the issuer processor (145), between the transaction handler (103) and the acquirer processor (147), and/or between the portal (143) and the transaction handler (103).

In one embodiment, the transaction handler (103) uses the data warehouse (149) to store the records about the transactions, such as the transaction records (e.g., 118) or transaction data (e.g., 118). In one embodiment, the transaction handler (103) includes a powerful computer, or cluster of computers functioning as a unit, controlled by instructions stored on a computer readable medium.

In one embodiment, the transaction handler (103) is configured to support and deliver authorization services, exception file services, and clearing and settlement services. In one embodiment, the transaction handler (103) has a subsystem to process authorization requests and another subsystem to perform clearing and settlement services.

In one embodiment, the transaction handler (103) is configured to process different types of transactions, such credit card transactions, debit card transactions, prepaid card transactions, and other types of commercial transactions.

In one embodiment, the transaction handler (103) facilitates the communications between the issuer processor (145) and the acquirer processor (147).

In one embodiment, the transaction handler (103) is coupled to the portal (143) (and/or a profile selector, an advertisement selector, a media controller) to charge the fees for the services of providing the transaction-based intelligence information and/or advertisement.

For example, in one embodiment, the system illustrated in FIG. 1 is configured to deliver advertisements, recommendations and/or suggestions to the point of interaction of the user, such as the user terminals (107 or 109), based on the transaction-based intelligence information; and the transaction handler (103) is configured to charge the advertisement fees to the account of the advertiser in communication with the issuer processor in control of the account of the advertiser. The advertisement fees may be charged in response to the presentation of the advertisement, or in response to the completion of a pre-determined number of presentations, or in response to a transaction resulting from the presentation of the advertisement. In one embodiment, the transaction handler (103) is configured to charge a periodic fee (e.g., a monthly fee, an annual fee) to the account of the advertiser in communication with the respective issuer processor that is similar to the issuer processor (145) of the consumer account (146).

For example, in one embodiment, the portal (143) is configured to provide transaction-based intelligence information in response to the queries received in the portal (143). The portal (143) is to identify the requesters (e.g., via an authentication, or the address of the requesters) and instruct the transaction handler (103) to charge the consumer accounts (e.g., 146) of the respective requesters for the transaction-based intelligence information. In one embodiment, the accounts of the requesters are charged in response to the delivery of the intelligence information via the portal (143). In one embodiment, the accounts of the requesters are charged a periodic subscription fee for the access to the query capability of the portal (143).

In one embodiment, the information service provided by the system illustrated in FIG. 1 includes multiple parties, such as one entity operating the transaction handler (103), one entity operating the portal (143), one entity operating the data warehouse (149), one entity operating the recommendation engine (121), etc. The transaction handler (103) is used to generate transactions to settle the fees and charges, and/or divide revenues using the accounts of the respective parties. In one embodiment, the account information of the parties is stored in the data warehouse (149) coupled to the transaction handler (103). In some embodiments, a separate billing engine is used to generate the transactions to settle the fees and charges, and/or divide revenues.

In one embodiment, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In one embodiment, the issuer processor (145) is to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. In one embodiment, the funds are transferred electronically.

In one embodiment, the transaction terminal (105) may submit a transaction directly for settlement, without having to separately submit an authorization request.

In one embodiment, the portal (143) provides a user interface to allow the user to organize the transactions in one or more consumer accounts (146) of the user with one or more issuers. The user may organize the transactions using information and/or categories identified in the transaction records (e.g., 118), such as merchant category, transaction date, amount, etc. Examples and techniques in one embodiment are provided in U.S. patent application Ser. No. 11/378,215, filed Mar. 16, 2006, assigned Pub. No. 2007/0055597, and entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. patent application Ser. No. 12/191,796, filed Aug. 14, 2008, assigned Pub. No. 2009/0048884, and entitled “Merchant Benchmarking Tool,” and Provisional U.S. Pat. App. Ser. No. 61/258,403, filed Nov. 5, 2009 and entitled “Systems and Methods for Analysis of Transaction Data,” the disclosures of which applications are hereby incorporated herein by reference.

### Transaction Terminal

FIG. 5 illustrates a transaction terminal according to one embodiment. In FIG. 5, the transaction terminal (105) is configured to interact with the account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or may be used in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 5. For example, in one embodiment, the transaction terminal (105) is configured for “card-not-present” (CNP) transactions; and the transaction terminal (105) does not have a reader (163).

In one embodiment, a transaction terminal (105) may have more components than those illustrated in FIG. 5. For example, in one embodiment, the transaction terminal (105) is an ATM machine, which includes components to dispense cash under certain conditions.

### Account Identification Device

FIG. 6 illustrates an account identification device according to one embodiment. In FIG. 6, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account (146) among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 6, such as a cellular communications subsystem.

In one embodiment, the communication device (159) may access the account information (142) stored on the memory (167) without going through the processor (151).

In one embodiment, the account identification device (141) has fewer components than those illustrated in FIG. 6. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction, such as user terminals (107, . . . , 109), is to provide an advertisement to the user, or to provide information derived from the transaction data (e.g., 118) to the user.

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction may be the same as the transaction terminal (105), such as a POS terminal, an ATM, a mobile phone, a computer of the user for an online transaction, etc. In one embodiment, the point of interaction may be co-located with, or near, the transaction terminal (105) (e.g., a video monitor or display, a digital sign), or produced by the transaction terminal (e.g., a receipt produced by the transaction terminal (105)). In one embodiment, the point of interaction may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user. In one embodiment, the white space is in a media channel that is used to report information about a transaction of the user, such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction with customers for transactions processed by the transaction handler (103) can be used to deliver advertisements relevant to the customers conducting the transactions; and the advertisements can be selected based at least in part on the intelligence information derived from the accumulated transaction data (e.g., 118) and/or the context at the point of interaction and/or the transaction terminal (105).

In general, a point of interaction may or may not be capable of receiving inputs from the customers, and may or may not co-located with a transaction terminal (e.g., 105) that initiates the transactions. The white spaces for presenting the advertisement on the point of interaction may be on a portion of a geographical display space (e.g., on a screen), or on a temporal space (e.g., in an audio stream).

In one embodiment, the point of interaction may be used primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction, which may be a non-portable consumer device or a portable computing device. The consumer device is to provide media content to the user and may receive input from the user.

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 7, with more or fewer components.

In one embodiment, the consumer device includes an account identification device (141). For example, a smart card used as an account identification device (141) is integrated with a mobile phone, or a PDA.

In one embodiment, the point of interaction is integrated with a transaction terminal (105). For example, a self-service checkout terminal includes a touch pad to interact with the user; and an ATM machine includes a user interface subsystem to interact with the user.

### Hardware

In one embodiment, a computing apparatus is configured to include some of the modules or components illustrated in FIGS. 1 and 4, such as the transaction handler (103), the recommendation engine (121), the portal (143), the transaction terminals (105), user terminals (107, . . . , 109), the issuer processor (145), the acquirer processor (147), and their associated storage devices, such as the data warehouse (149).

In one embodiment, at least some of the modules or components illustrated in FIGS. 1 and 4, such as the transaction handler (103), the transaction terminal (105), the portal (143), the issuer processor (145), the acquirer processor (147), and the account identification device (141), can be implemented as a computer system, such as a data processing system illustrated in FIG. 7, with more or fewer components. Some of the modules may share hardware or be combined on a computer system. In one embodiment, a network of computers can be used to implement one or more of the modules.

Further, the data illustrated in FIG. 1, such as transaction data (e.g., 118), ratings (117), comments (119), and other data such as account data, transaction profiles, and advertisement data, can be stored in storage devices of one or more computers accessible to the corresponding modules illustrated in FIG. 1. For example, the transaction data (e.g., 118) can be stored in the data warehouse (149) that can be implemented as a data processing system illustrated in FIG. 7, with more or fewer components.

In one embodiment, the transaction handler (103) is a payment processing system, or a payment card processor, such as a card processor for credit cards, debit cards, etc.

FIG. 7 illustrates a data processing system according to one embodiment. While FIG. 7 illustrates various components of a computer system, it is not intended to represent any particular architecture or manner of interconnecting the components. One embodiment may use other systems that have fewer or more components than those shown in FIG. 7.

In FIG. 7, the data processing system (170) includes an inter-connect (171) (e.g., bus and system core logic), which interconnects a microprocessor(s) (173) and memory (167). The microprocessor (173) is coupled to cache memory (179) in the example of FIG. 7.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
storing, by a computing device, data grouping a plurality of accounts;
storing, by the computing device, transaction data of the plurality of accounts, wherein the transaction data records a plurality of transactions processed at a transaction handler, each of the transactions being processed to make a payment from an issuer to an acquirer via the transaction handler in response to an account identifier of the plurality of accounts, as issued by the issuer to a user, being submitted by a merchant to the acquirer, the issuer to make the payment on behalf of the user, the acquirer to receive the payment on behalf of the merchant;
determining, by the computing device, preference scores of merchants based at least in part on spending amounts recorded in the transaction data of the plurality of accounts; and
providing, by the computing device, recommendations of merchants based on the preference scores to an account holder of a first account of the plurality of accounts.

2. The method of claim 1, further comprising:
receiving, in the computing device, a request identifying the first account of the plurality of accounts via a portal of a business, wherein the plurality of accounts are issued to account holders of the business;
wherein the recommendations are provided to an account holder of the first account via the portal of the business.

3. The method of claim 2, wherein the request identifies a location; and the recommendations are for merchants located in the vicinity of the location.

4. The method of claim 3, wherein the recommendations are related to at least one of: hotels and restaurants; and the recommendations are further in accordance with travel policies of the business.

5. The method of claim 4, further comprising:
receiving, in the computing device, feedback data from the account holders of the business, the feedback data comprising comments and ratings;
wherein the recommendations provided in response to the request include the feedback data related to respective merchants.

6. The method of claim 5, further comprising:
providing, by the computing device, a user interface to the user to view records of transactions of the user recorded in the transaction data, wherein the user interface is further configured to receive comments on and ratings of merchants of respective transactions.

7. The method of claim 1, wherein the preference scores are further based on spending frequency of transactions with the merchants as recorded in the transaction data of the plurality of accounts.

8. The method of claim 1, further comprising:
identifying a spending pattern in the transaction data of the plurality of accounts; and
detecting a fraudulent transaction in the first account of the plurality of accounts based on the spending pattern.

9. The method of claim 8, further comprising:
storing, by the computing device, a communication reference of the account holder in association with the first account; and
transmitting, by the computing device, an alert to the account holder using the communication reference in response to the fraudulent transaction being detected based on the spending pattern.

10. The method of claim 1, further comprising:
monitoring transactions in the first account;
wherein the recommendations are provided in response to transactions relevant to the recommendations.

11. The method of claim 10, wherein the recommendations are provided further based on a location of a mobile device of the account holder.

12. The method of claim 11, wherein the recommendations are provided to the mobile device.

13. The method of claim 1, wherein the plurality of accounts are grouped via a social networking application.

14. The method of claim 13, further comprising:
communicating with a social networking site to determine friends of the account holder of the first account; and
identifying the plurality of accounts based on identities of the friends.

15. A tangible computer-readable medium storing instructions configured to instruct a computing device to perform a method, the method comprising:
storing, by the computing device, transaction data of a plurality of accounts, wherein the transaction data records a plurality of transactions processed at a transaction handler, each of the transactions being processed to make a payment from an issuer to an acquirer via the transaction handler in response to an account identifier of the plurality of accounts, as issued by the issuer to a user, being submitted by a merchant to the acquirer, the issuer to make the payment on behalf of the user, the acquirer to receive the payment on behalf of the merchant;
determining, by the computing device, preference scores of merchants based at least in part on spending amounts recorded in the transaction data of the plurality of accounts; and
providing, by the computing device, recommendations of merchants based on the preference scores to an account holder of a first account of the plurality of accounts.

16. A computing apparatus, comprising:
a data warehouse configured to store data grouping a set of accounts, and transaction data recording transactions in the set of accounts;
a transaction handler configured to process each of the transactions in response to an account identifier of a respective account in the plurality of accounts being submitted from an acquirer processor on behalf of a merchant for a payment from an issuer processor associated with an issuer of the respective account; and
a portal coupled with the data warehouse to compute preference scores of merchants identified in the transaction data using at least transaction amounts recorded in the transaction data and provide recommendations of merchants to users of the accounts based on the preference score.

17. The computing apparatus of claim 16, further comprising:
an advertisement selector coupled with the data warehouse to identify a recommendation of a first merchant in response to a first transaction in the set of accounts.

18. The computing apparatus of claim 17, further comprising:
a media controller coupled with the advertisement selector to transmit the recommendation to a mobile device of a user of the first transaction.

19. The computing apparatus of claim 18, wherein the advertisement selector is configured to select the recommendation based on a distance between the mobile device of the user of the first transaction and a location of the first merchant.

20. The computing apparatus of claim 19, further comprising:
a transaction profile generator coupled with the data warehouse to generate a transaction profile of the user, wherein the recommendation is further selected based on the transaction profile.
